(19) United States
(12) Patent Application Publication
(10) Pub. No.: US 2013/0230659 A1
(43) Pub. Date: Sep. 5, 2013

(54) FINE-POROSITY CERAMIC COATING VIA SPPS

(71) Applicants: Ludger Quick, Dortmund (DE); Werner Stamm, Mulheim an der Ruhr (DE)

(72) Inventors: Ludger Quick, Dortmund (DE); Werner Stamm, Mulheim an der Ruhr (DE)

(21) Appl. No.: 13/884,308

(22) PCT Filed: Oct. 19, 2011
(86) PCT No.: PCT/EP2011/068225

§ 371 Date: May 9, 2013

(30) Foreign Application Priority Data
Nov. 10, 2010 (DE) 10190672.5

(51) Int. Cl. C04B 35/505

(52) U.S. Cl. CPC C04B 35/505
USPC 427/453; 427/427

(57) ABSTRACT

A process is provided for producing a fine-pored ceramic layer composed of zirconium oxide or gadolinium zirconate or ytterbium zirconate or europium zirconate or lanthanum zirconate on a substrate and/or on a metallic layer. The process includes spraying at least one water-soluble and dissolved salt. In the process, water soluble salts of zirconium and gadolinium or ytterbium or europium or lanthanum are added for the zirconates.

### CROSS REFERENCE TO RELATED APPLICATIONS

This application is the US National Stage of International Application No. PCT/EP2011/068225 filed Oct. 19, 2011 and claims benefit thereof, the entire content of which is hereby incorporated herein by reference. The International Application claims priority to the European application No. 10190672.5 EP filed Nov. 10, 2010, the entire contents of which is hereby incorporated herein by reference.

### FIELD OF INVENTION

The invention relates to a thermal barrier layer which is applied by an SPPS (solution precursor plasma spray) process.

### BACKGROUND OF INVENTION

Ceramic thermal barrier layers are frequently applied to components subject to very high thermal stress in order to increase the working temperatures. Here, the porosity plays an important role in the life of the protected ceramic layer.

### SUMMARY OF INVENTION

It is therefore an object of the invention to indicate an improved ceramic layer having improved porosity.

The object is achieved by the features of the independent claim(s).

The dependent claims list further advantageous measures which can be combined with one another in any way in order to achieve further advantages.

### BRIEF DESCRIPTION OF THE DRAWINGS

The figures show:

FIG. 1 a layer system,

FIG. 2 a turbine blade,

FIG. 3 a combustion chamber,

FIG. 4 a gas turbine,

FIG. 5 a list of superalloys.

### DETAILED DESCRIPTION OF INVENTION

The descriptions and figures merely represent examples of the invention.

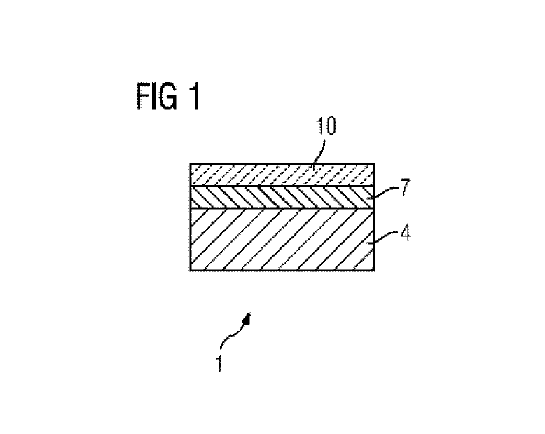

FIG. 1 shows a layer system having a ceramic layer.

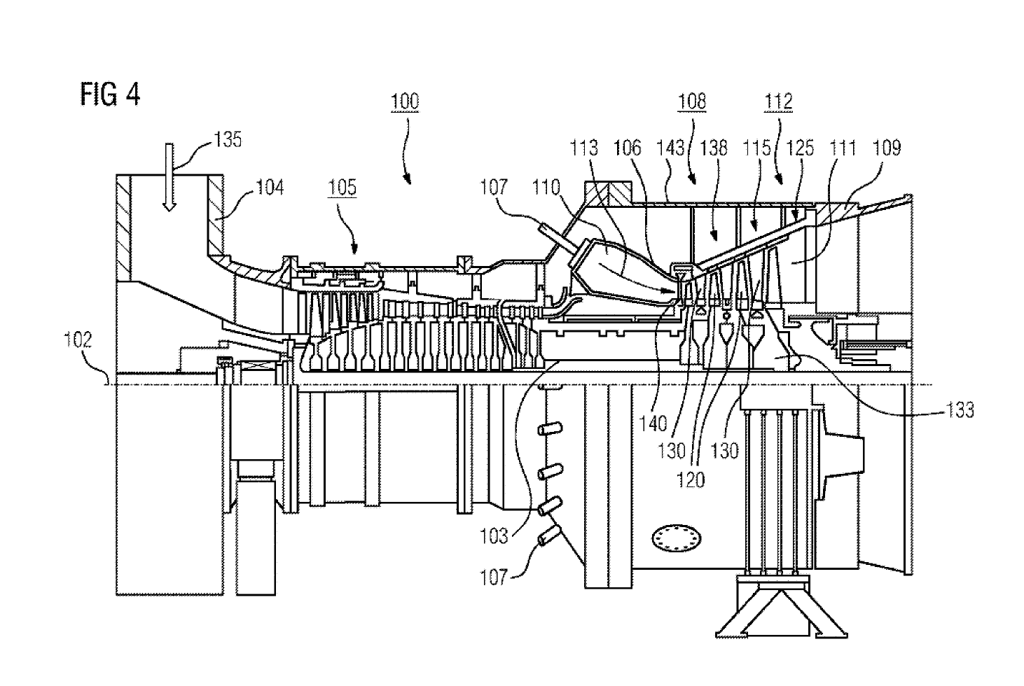

Such a layer system 1 is preferably a turbine blade 120, 130 of a turbine, in particular a gas turbine 100 (FIG. 4), which is explained in more detail here as illustrating component.

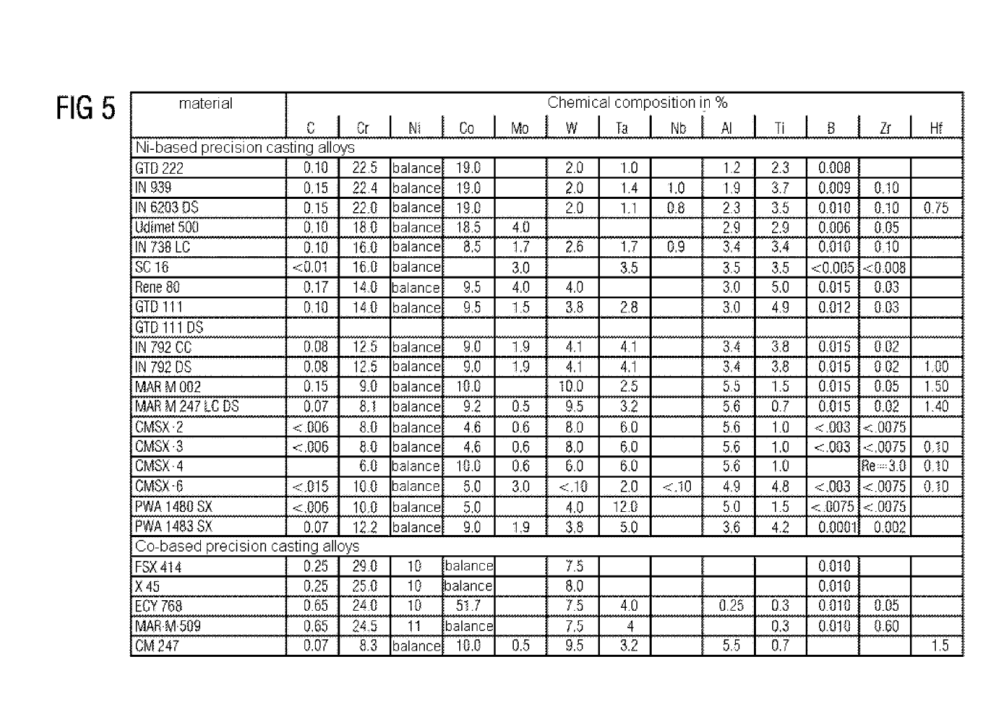

The layer system 1 has a substrate 4. The substrate is preferably made of a nickel-based superalloy (FIG. 5).

The preferably metallic substrate 4 is preferably provided with a metallic bonding layer 7 to an outer ceramic layer 10. However, there are also systems in which the ceramic layer 10 is applied directly to the substrate 4 which then also preferably has a diffusion layer in the substrate 4.

A metallic bonding layer and corrosion protection layer 7 which preferably comprises an MCrAl(Y) alloy is preferably present.

The outer, in particular outermost, layer of the layer system 1 is the ceramic layer 10 which is present as a single layer or a double layer, with or without chemical gradients.

As material for the ceramic layer 10, it is possible to use zirconium oxide or gadolinium zirconate or ytterbium zirconate, europium zirconate or lanthanum zirconate or mixed crystals.

Such a ceramic layer 10 is sprayed by means of a liquid precursor onto the substrate 4 or the metallic layer 7 is preferably sprayed by means of a plasma (SPPS).

The porosity in the range from 8% by volume to 25% by volume is set by use of salt solutions metered in different amounts.

The advantages of this coating method are a fine porosity distribution, the possibility of spraying nanoparticles and the easier setting of gradient composition.

As water-soluble salts for the SPPS process, preference is given to using the following starting materials:

| Material | water-soluble salts |
|---|---|
| for zirconium | zirconium tetrachloride: ZrCl₄ |
| | zirconium tetraiodide: Zrl₄ |
| | zirconium nitrate pentahydrate: Zr(NO₃)₄5H₂O |
| | zirconium sulfate: Zr(SO₄)₂ |
| | zirconium sulfate tetrahydrate: Zr(SO₄)₂4H₂O |
| for gadolinium | gadolinium chloride: GdCl₃ |
| | gadolinium chloride hexahydrate: GdCl₃6H₂O |
| | gadolinium bromide hexahydrate: GdBr₃6H₂O |
| | gadolinium iodide: GdI₃ |
| | gadolinium nitrate hexahydrate: Gd(NO₃)₃6H₂O |
| for ytterbium | ytterbium(II) chloride: YbCl₂ |
| | ytterbium(III) chloride hexahydrate: YbCl₃6H₂O |
| | ytterbium(II) bromide: YbBr₂ |
| | ytterbium(III) bromide: YbBr₃ |
| | ytterbium(II) iodide: YbI₂ |
| | ytterbium(III) iodide: YbI₃ |
| for europium | europium(II) chloride: EuCl₂ |
| | europium(II) bromide: EuBr₂ |
| | europium(III) bromide: EuBr₃ |
| | europium(II) iodide: EuI₂ |
| | europium(III) iodide: EuI₃ |
| | europium(III) nitrate: Eu(NO₃)₃ |
| for lanthanum | lanthanum chloride heptahydrate: LaCl₃7H₂O |
| | lanthanum chloride: LaCl₃ |
| | lanthanum bromide heptahydrate: LaBr₃7H₂O |
| | lanthanum iodide: LaI₃ |

For zirconium oxide, one or more of the salts for zirconium are employed.

For the zirconates, one or more salts for zirconium and one or more appropriate salts for Gd, La, Eu or Yb or mixtures (for mixed crystals) thereof are used.

Thus, for example, zirconium tetrachloride and gadolinium chloride or the hydrate are mixed with one another in one solution or by addition during spraying in order to obtain the elements gadolinium and zirconium as elements in the ceramic layer composed of a gadolinium zirconate.

The corresponding oxides (ZrO₂, Gd—Zr—O, La—Zr—O, . . . ) are formed by oxidation.

Instead of zirconium, it is also possible to use corresponding salts of hafnium in order to produce hafnium oxide or hafnates with Gd, La, Eu or Yb.

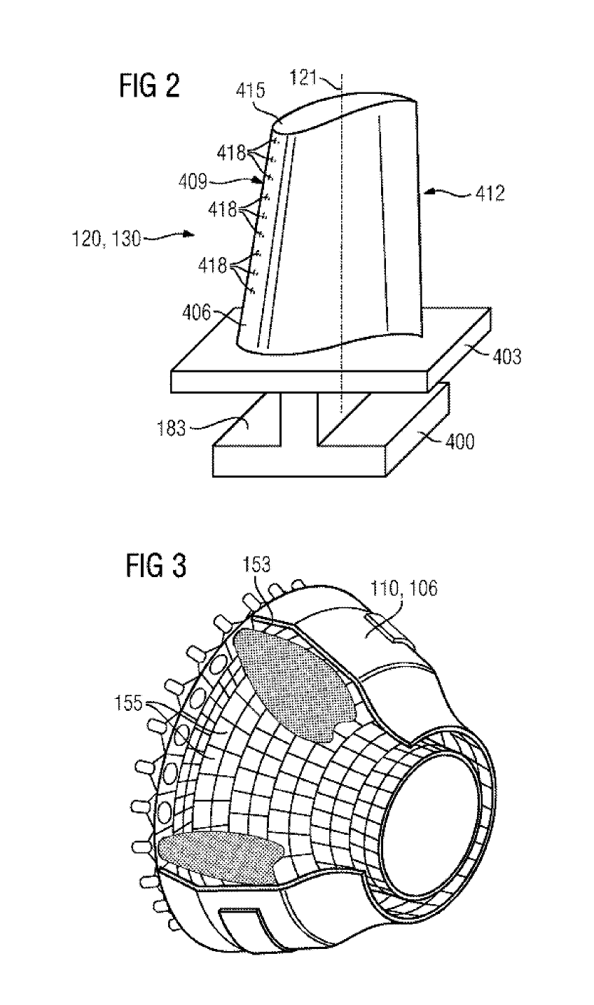

FIG. 2 shows a perspective view of a rotating blade 120 or guide blade 130 of a flow engine, which extends along a longitudinal axis 121.

The flow engine can be a gas turbine of an aircraft or of a power station for electricity generation, a steam turbine or a compressor.

The blade 120, 130 has, in succession along the longitudinal axis 121, a fastening region 400, an adjoining blade platform 403 and a blade body 406 and a blade tip 415.

As guide blade 130, the blade 130 can have a further platform (not shown) as its blade tip 415.

A blade base 183 which serves for fastening the rotating blades 120, 130 to a shaft or a plate (not shown) is formed in the fastening region 400.

The blade base 183 is, for example, configured as a hammer head. Other configurations as fir-tree or swallowtail base are possible.

The blade 120, 130 has a leading edge 409 and a trailing edge 412 for a medium which flows past the blade body 406.

In the case of conventional blades 120, 130, solid metallic materials, in particular superalloys, are, for example, used in all regions 400, 403, 406 of the blade 120, 130.

Such superalloys are known, for example, from EP 1 204 776 B1, EP 1 306 454, EP 1 319 729 A1, WO 99/67435 or WO 00/44949.

The blade 120, 130 can have been manufactured by a casting process, including by means of directional solidification, by a forging process, by a milling process or combinations thereof.

Workpieces having a single-crystal structure or structures are used as components for engines which are subjected to high mechanical, thermal and/or chemical stresses in operation.

The manufacture of such single-crystal workpieces is carried out by, for example, directional solidification from the melt. The processes employed here are casting processes in which the liquid metallic alloy solidifies to form a single-crystal structure, i.e. a single-crystal workpiece, or directionally.

Here, dendritic crystals are aligned along the heat flow and form either a stem-like crystalline grain structure (columnar, i.e. grains which run along the entire length of the workpiece and are referred to here, in accordance with generally used terminology, as directionallysolidified) or a single-crystal structure, i.e. the entire workpiece consists of a single crystal. In these processes, the transition to globulitic (polycrystalline) solidification has to be avoided since transverse and longitudinal grain boundaries are necessarily formed as a result of polydirectional growth, and these nullify the good properties of the directionally solidified or single-crystal component.

When directionally solidified microstructures are spoken of in general, what is meant encompasses both single crystals which have no grain boundaries or at most small-angle grain boundaries and also stem-like crystal structures which have grain boundaries running in the longitudinal direction but no transverse grain boundaries. These second crystalline structures mentioned are also referred to as directionally solidified structures.

Such processes are known from U.S. Pat. No. 6,024,792 and EP 0 892 090 A1.

The blades 120, 130 can likewise have coatings to protect against corrosion or oxidation, e.g. (MCrAlX; M is at least one element from the group consisting of iron (Fe), cobalt (Co), nickel (Ni), X is an active element and is yttrium (Y) and/or silicon and/or at least one element of the rare earths, or hafnium (Hf)). Such alloys are known from EP 0 486 489 B1, EP 0 786 017 B1, EP 0 412 397 B1 or EP 1 306 454 A1.

The density is preferably 95% of the theoretical density.

A protective aluminum oxide layer (TGO=thermal grown oxide layer) is formed (as intermediate layer or as outermost layer) on the MCrAlX layer.

The layer composition preferably comprises Co-30Ni-28Cr-8Al-0.6Y-0.75i or Co-28Ni-24Cr-10Al-0.6Y. Apart from these cobalt-based protective layers, preference is also given to using nickel-based protective layers such as Ni-10Cr-12Al-0.6Y-3Re or Ni-12Co-21Cr-11Al-0.4Y-2Re or Ni-25Co-17Cr-10Al-0.4Y-1.5Re.

A thermal barrier layer can be additionally present on the MCrAlX and is then preferably the outermost layer and consists, for example, of ZrO₂, Y₂O₃—ZrO₂, i.e. it is not stabilized, partially stabilized or fully stabilized by yttrium oxide and/or calcium oxide and/or magnesium oxide.

The thermal barrier layer covers the entire MCrAlX layer. Stem-like grains are produced in the thermal barrier layer by means of suitable coating processes, e.g. electron beam vaporization (EB-PVD).

Other coating processes are conceivable, e.g. atmospheric plasma spraying (APS), LPPS, VPS or CVD. The thermal barrier layer can have porous, microcrack- or macrocrack-containing grains to improve the thermal shock resistance. The thermal barrier layer is thus preferably more porous than the MCrAlX layer.

Refurbishment means that components 120, 130 optionally have to be freed of protective layers (e.g. by sand blasting) after use. Removal of the corrosion and/or oxidation layers or products is then carried out. Cracks in the component 120, 130 are optionally also repaired. This is followed by recoating of the component 120, 130 and renewed use of the component 120, 130.

The blade 120, 130 can be hollow or solid. If the blade 120, 130 is to be cooled, it is hollow and optionally also has film cooling holes 418 (indicated by broken lines).

FIG. 3 shows a combustion chamber 110 of a gas turbine. The combustion chamber 110 is, for example, configured as an annular combustion chamber in which a plurality of burners 107 arranged in the circumferential direction around an axis of rotation 102 open into a common combustion chamber space 154, producing flames 156.

For this purpose, the combustion chamber 110 in its totality is configured as an annular structure positioned around the axis of rotation 102.

To achieve a comparatively high efficiency, the combustion chamber 110 is designed for a comparatively high temperature of the working medium M of from about 1000° C. to 1600° C. To make a comparatively long operating life possible even at these operating parameters which are unfavorable for the materials, the combustion chamber wall 153 is provided on its side facing the working medium M with an interior lining made up of heat shield elements 155.

Each heat shield element 155 composed of an alloy is provided on the working medium side with a particularly heat-resistant protective layer (MCrAlX layer and/or ceramic coating) or is made of high-temperature-resistant material (solid ceramic bricks).

These protective layers can be similar to the turbine blades, i.e., for example, in MCrAlX: M is at least one element from the group consisting of iron (Fe), cobalt (Co), nickel (Ni), X is an active element and is yttrium (Y) and/or silicon and/or at least one element of the rare earths, or hafnium (Hf). Such alloys are known from EP 0 486 489 B1, EP 0 786 017 B1, EP 0 412 397 B1 or EP 1 306 454 A1.

A ceramic thermal barrier layer, for example, can be additionally present on the MCrAlX and consists, for example, of ZrO₂, Y₂O₃—ZrO₂, i.e. it is not stabilized, partially stabilized or fully stabilized by yttrium oxide and/or calcium oxide and/or magnesium oxide.

Stem-shaped grains are produced in the thermal barrier layer by suitable coating processes, e.g. electron beam vaporization (EB-PVD).

Other coating processes are conceivable, e.g. atmospheric plasma spraying (APS), LPPS, VPS or CVD. The thermal barrier layer can have porous, microcrack- or macrocrack-containing grains to improve thermal shock resistance.

Refurbishment means that heat shield elements 155 optionally have to be freed of protective layers (e.g. by sand blasting) after use. Removal of the corrosion and/or oxidation layers or products is then carried out. Cracks in the heat shield element 155 are optionally also repaired. This is followed by recoating of the heat shield elements 155 and renewed use of the heat shield elements 155.

Owing to the high temperatures in the interior of the combustion chamber 110, a cooling system can additionally be provided for the heat shield elements 155 or for their holders. The heat shield elements 155 are then, for example, hollow and optionally also have cooling holes (not shown) opening into the combustion chamber space 154.

FIG. 4 shows, by way of example, a gas turbine 100 in a longitudinal partial section.

The gas turbine 100 has, in its interior, a rotor 103 which is rotatably mounted around an axis of rotation 102 and has a shaft 101, which is also referred to as turbine rotor.

Along the rotor 103 there are, in succession, an intake housing 104, a compressor 105, a for example torus-like combustion chamber 110, in particular an annular combustion chamber, having a plurality of coaxially arranged burners 107, a turbine 108 and the exhaust gas housing 109.

The annular combustion chamber 110 communicates with a for example annular hot gas channel 111. There, for example, four turbine stages 112 connected in series form the turbine 108.

Each turbine stage 112 is, for example, made up of two rings of blades. Viewed in the flow direction of a working medium 113, a row of guide blades 115 is followed by a row 125 made up of rotating blades 120 in the hot gas channel 111.

The guide blades 130 are fastened to an inner housing 138 of a stator 143, while the rotating blades 120 of a row 125 are, for example, attached by means of a turbine disk 133 to the rotor 103.

A generator or a working machine (not shown) is coupled to the rotor 103.

During operation of the gas turbine 100, air 135 is drawn in through the intake housing 104 by the compressor 105 and compressed. The compressed air provided at the turbine end of the compressor 105 is conveyed to the burners 107 and mixed there with a fuel. The mixture is then burnt in the combustion chamber 110 to form the working medium 113. From there, the working medium 113 flows along the hot gas channel 111 past the guide blades 130 and the rotating blades 120. At the rotating blades 120, the working medium 113 is decompressed to impart momentum, so that the rotating blades 120 drive the rotor 103 and the latter drives the working machine coupled thereto.

The components exposed to the hot working medium 113 are subject to thermal stresses during operation of the gas turbine 100. The guide blades 130 and rotating blades 120 of the first, viewed in the flow direction of the working medium 113, turbine stage 112 and also the heat shield elements lining the annular combustion chamber 110 are subject to the greatest thermal stresses.

In order to withstand the temperatures prevailing there, these components can be cooled by means of a cooling medium.

Likewise, substrates of the components can have an oriented structure, i.e. they are single crystals (SX structure) or have only longitudinally oriented grains (DS structure).

Materials used for the components, in particular for the turbine blade 120, 130 and components of the combustion chamber 110 are, for example, iron-, nickel- or cobalt-based superalloys.

Such superalloys are known, for example, from EP 1 204 776 B 1, EP 1 306 454, EP 1 319 729 A1, WO 99/67435 or WO 00/44949.

The blades 120, 130 can likewise have coatings to protect against corrosion (MCrAlX; M is at least one element of the group consisting of iron (Fe), cobalt (Co), nickel (Ni), X is an active element and is yttrium (Y) and/or silicon, scandium (Sc) and/or at least one element of the rare earths or hafnium). Such alloys are known from EP 0 486 489 B1, EP 0 786 017 B1, EP 0 412 397 B1 or EP 1 306 454 A1.

A thermal barrier layer can be additionally present on the MCrAlX and consists, for example, of ZrO₂, Y₂O₃—ZrO₂, i.e. it is not stabilized, partially stabilized or fully stabilized by yttrium oxide and/or calcium oxide and/or magnesium oxide.

Stem-like grains are produced in the thermal barrier layer by suitable coating processes, e.g. electron beam vaporization (EB-PVD).

The guide blade 130 has a guide blade base (not shown here) facing the interior housing 138 of the turbine 108 and a guide blade head opposite the guide blade base. The guide blade head faces the rotor 103 and is fixed to a fastening ring 140 of the stator 143.

1-9. (canceled)

10. A process for producing a fine-pored ceramic layer composed of zirconium oxide or gadolinium zirconate or ytterbium zirconate or europium zirconate or lanthanum zirconate on a substrate and/or on a metallic layer, the process comprising:
spraying at least one water-soluble and dissolved salt,
wherein water soluble salts of zirconium and gadolinium or ytterbium or europium or lanthanum are added for the zirconates.

11. The process as claimed in claim 10, wherein the spraying is carried out by means of a plasma.

12. The process as claimed in claim 10, wherein the salts of zirconium are selected from the group consisting of:
zirconium tetrachloride: ZrCl₄,
zirconium tetraiodide: ZrI₄,
zirconium nitrate pentahydrate: Zr(NO₃)₄ 5H₂O,
zirconium sulfate: Zr(SO₄)₂, and
zirconium sulfate tetrahydrate: Zr(SO₄)₂ 4H₂O.

13. The process as claimed in claim 10, wherein the salts of gadolinium are selected from the group consisting of:
gadolinium chloride: GdCl₃,
gadolinium chloride hexahydrate: GdCl₃ 6H₂O,
gadolinium bromide hexahydrate: GdBr₃ 6H₂O,
gadolinium iodide: GdI₃, and
gadolinium nitrate hexahydrate: Gd(NO₃)₃.

14. The process as claimed in claim 10, wherein the salts of ytterbium are selected from the group consisting of:
ytterbium(II) chloride: YbCl₂,
ytterbium(III) chloride hexahydrate: YbCl₃ 6H₂O,
ytterbium(II) bromide: YbBr₂,
ytterbium(III) bromide: YbBr₃,
ytterbium(II) iodide: YbI₂, and
ytterbium(III) iodide: YbI₃.

15. The process as claimed in claim 10, wherein the salts of europium are selected from the group consisting of:
europium(II) chloride: EuCl₂,
europium(II) bromide: EuBr₂,
europium(III) bromide: EuBr₃,
europium(II) iodide: EuI₂,
europium(III) iodide: EuI₃, and
europium(III) nitrate: Eu(NO₃)₃.

16. The process as claimed in claim 10, wherein the salts of lanthanum are selected from the group consisting of:
lanthanum chloride heptahydrate: LaCl₃ 7H₂O,
lanthanum chloride: LaCl₃,
lanthanum bromide heptahydrate: LaBr₃ 7H₂O, and
lanthanum iodide: LaI₃.

17. The process as claimed in claim 10, wherein a porosity in the range from 8% by volume to 25% by volume is set by use of salt solutions added in different amounts.

18. The process as claimed in claim 10, further comprising setting materials gradients in the layer by mixing of salts.

19. The process as claimed in claim 10, further comprising spraying nanoparticles concomitantly.

20. The process as claimed in claim 10, wherein (Gd, Yb, La, Eu) salts of hafnium are used for hafnium oxide and/or hafnates.

21. The process as claimed in claim 10, wherein a metallic substrate composed of a nickel- or cobalt-based superalloy is coated.

22. The process as claimed in claim 10, wherein the metallic layer is a diffusion layer and/or overlay layer, in particular an MCrAl(Y) layer.

23. The process as claimed in claim 10, wherein the salts oxidize and/or react with one another so as to form an oxide ceramic as coating.

24. The process as claimed in claim 10, comprising producing a two-layer ceramic layer using the salts.

25. The process as claimed in claim 24, wherein the two-layer ceramic layer comprises a lower zirconium oxide layer and an upper zirconate layer or hafnate layer,

26. The process as claimed in claim 25, wherein the hafnate layer is gadolinium-based.
